(19) United States
(12) Patent Application Publication
(10) Pub. No.: US 2026/0338112 A1
(43) Pub. Date: Oct. 29, 2026

(54) AIR TURBOROCKET APPARATUS WITH BOILER

(71) Applicant: DESTINUS SA, Payerne (CH)

(72) Inventors: Ferran ROIG TIÓ, Payerne (CH); Mikhail KOKORICH, Payerne (CH)

(21) Appl. No.: 19/124,240

(22) PCT Filed: Oct. 25, 2022
(86) PCT No.: PCT/EP2022/079741

§ 371 Date: Apr. 24, 2025

(51) Int. Cl. F02C 7/224; F02K 9/78

(52) U.S. Cl. CPC F02C 7/224; F02K 9/78

(57) ABSTRACT

The invention is notably directed to an air turborocket apparatus (10). The apparatus includes an air intake (11), a compressor (12), a turbine (13), a gas generator system, a coupling system (19), a combustion chamber (14), and a nozzle (15). The air intake is designed to receive atmospheric air. The compressor is designed to compress atmospheric air received by the air intake, in operation. The gas generator system includes a fluid circuit (G0-G1.3), which defines a flow path to the turbine, and a driving system, which is designed to convey a fluid along the fluid circuit for the fluid to expand through the turbine and rotate it. The coupling system couples the turbine with one or each of the compressor and the driving system, with a view to transferring energy to one or each of the compressor and the driving system. The combustion chamber is designed to receive and combust a mixture of the compressed atmospheric air and the expanded fluid, while the nozzle is arranged to expel the combusted mixture and thereby create thrust, in operation. Remarkably, the apparatus further includes a boiler (18), which is designed to generate heat. The boiler is in thermal communication (21) with said flow path to transfer the generated heat to the fluid conveyed along said flow path, in operation. The invention is further directed to an aircraft (1) equipped with such an air turborocket apparatus, as well as methods of operating such air turborocket apparatuses.

### BACKGROUND

The invention relates in general to the field of air turborocket apparatuses, aircrafts including such apparatuses, and method of operating the same. In particular, it is directed to an air turborocket apparatus including a boiler used to preheat fuel that is subsequently expanded through a turbine, so as to more efficiently drive a compressor and a pump of the apparatus.

An air turborocket (also called turboramjets or turboramjet rocket) can be regarded as a combined-cycle jet engine, i.e., an expander cycle engine that uses heat from the combustion to energize the fuel so that it can be expanded in a turbine to drive a fuel pump and/or a compressor.

The heat transfer rate required for useful levels of thrust is significant. The available hot area, according to which heat can be transferred from the hot stream to the initially cold fuel, is a limiting factor of the engine efficiency. If there is not enough area to transfer the amount of heat required for a particular engine design, the expander cycle cannot be optimally used.

Therefore, the invention aims at providing an efficient solution to transfer heat to the cold fuel.

### SUMMARY

According to a first aspect, the present invention is embodied as an air turborocket apparatus. The apparatus includes an air intake, a compressor, a turbine, a gas generator system, a coupling system, a combustion chamber, and a nozzle. The air intake is designed to receive atmospheric air. The compressor is designed to compress atmospheric air received by the air intake, in operation. The gas generator system includes a fluid circuit, which defines a flow path to the turbine, and a driving system, which is designed to convey a fluid along the fluid circuit for the fluid to expand through the turbine and rotate it. The coupling system couples the turbine with one or each of the compressor and the driving system, with a view to transferring energy to one or each of the compressor and the driving system. The combustion chamber is designed to receive and combust a mixture of the compressed atmospheric air and the expanded fluid, while the nozzle is arranged to expel the combusted mixture and thereby create thrust, in operation. Interestingly, the apparatus further includes a boiler, which is designed to generate heat. The boiler is in thermal communication with said flow path to transfer the generated heat to the fluid conveyed along the flow path, in operation.

The present solution provides an additional area for heat exchange, i.e., an additional surface through which heat can be transferred to the fluid circuit, while requiring minimal power. The boiler leads to minimal fuel consumption increase, should it be based on fuel combustion, as in preferred embodiments. The boiler preferably uses the same liquid fuel as used in the main combustion line.

In embodiments, the coupling system couples the turbine with the compressor, whereby the rotated turbine at least contributes to rotate the compressor to accordingly compress the atmospheric air received by the air intake, in operation.

Preferably, the driving system includes a pump designed to pump liquid fuel. The pump is connected to the fluid circuit to inject the pumped liquid fuel into the fluid circuit, whereby the fluid to be conveyed along the fluid circuit is obtained from the pumped liquid fuel, in operation.

In preferred embodiments, the coupling system couples the turbine with the pump, whereby the rotated turbine at least contributes to actuate the pump, in operation. The turbine is preferably coupled to each of the pump and the compressor.

Preferably, the fluid circuit comprises two subcircuits, these including a first subcircuit and a second subcircuit. The first subcircuit connects the pump to the boiler, which can accordingly combust a fluid formed from the pumped liquid fuel, while the second subcircuit connects the pump to the turbine, thereby defining said flow path to the turbine.

In embodiments, the apparatus further includes a first heat exchanger, which thermally connects the boiler and a portion of the flow path defined by the second subcircuit, to transfer the generated heat to the fluid conveyed along the second subcircuit.

Preferably, the apparatus further includes a second heat exchanger arranged along the second subcircuit, upstream of the first heat exchanger, to transfer heat from the combustion chamber and/or the nozzle to fluid conveyed along the second subcircuit.

More preferably, the driving system further includes a third heat exchanger arranged along the second subcircuit, upstream of the second heat exchanger, to transfer heat from the atmospheric air received by the air intake to fluid conveyed along the second subcircuit.

In embodiments, the boiler is designed to combust fuel and produce a low-pressure combustion gas flow, while the gas generator is designed to produce a high-pressure flow of the fluid in the fluid circuit.

For example, the boiler can be designed to produce said low-pressure combustion gas flow inside a duct delimited by an inner wall of the boiler. The duct is typically not in fluid communication with said fluid circuit.

Preferably, a portion of the fluid circuit includes a conduit that is coiled around the duct, thereby forming a heat exchanger to transfer the generated heat to the fluid conveyed along said conduit.

The conduit may for instance be coiled inside the boiler, against said inner wall of the boiler. In variants, said portion of the conduit is coiled around the boiler, against an outer wall of the boiler.

Preferably, the apparatus further includes an air inlet configured to transfer part of the atmospheric air compressed by the compressor to the boiler, in operation.

According to another aspect, the invention is embodied as an aircraft comprising one or more air turborocket apparatuses such as described above. Preferably, the aircraft further includes one or more fuel tanks, to which the gas generator system and the boiler are connected.

According to another aspect, the invention is embodied as a method of operating an air turborocket apparatus. The method relies on an air turborocket apparatus as described above. The method basically amounts to operating the air turborocket apparatus for the air intake to receive atmospheric air and the compressor to compress atmospheric air received by the air intake. The driving system conveys a fluid along the fluid circuit for the fluid to expand through the turbine and rotate it, so as to transfer energy to one or each of the compressor and the driving system. Meanwhile, the boiler generates heat and transfers the generated heat to the fluid conveyed along said flow path. The combustion chamber receives and combusts a mixture of the compressed atmospheric air and the expanded fluid, and the nozzle expels the combusted mixture to thereby create thrust, consistently with features of the apparatus described above.

### BRIEF DESCRIPTION OF THE DRAWINGS

These and other objects, features and advantages of the present invention will become apparent from the following detailed description of illustrative embodiments thereof, which is to be read in connection with the accompanying drawings. The illustrations are for clarity in facilitating one skilled in the art in understanding the invention in conjunction with the detailed description. In the drawings:

FIGS. 1 and 2 respectively show a 3D view and a rear view of a high-speed aircraft equipped with an air turborocket, according to embodiments;

FIG. 3 is a schematic of an air turborocket apparatus according to embodiments, illustrating the interplay between the main combustion line and the fuel circuit, whereby fuel conveyed along the fluid circuit is heated by components of the air turborocket apparatus, which notably includes a boiler to help heat the fuel;

FIG. 4 is a 3D view of such an air turborocket, according to embodiments;

FIG. 5 schematically illustrates the propagation of fuel along a fluid circuit of the air turborocket of FIG. 4, whereby heat is transferred by a boiler to fuel conveyed in that fluid circuit, before the fuel expands through the turbine, as in embodiments; and

FIG. 6 is another diagram schematically illustrating selected components of an air turborocket according to embodiments, the function of such components, and how these components interact in operation of the air turborocket, as in embodiments.

The accompanying drawings show simplified representations of devices or parts thereof, as involved in embodiments. Technical features depicted in the drawings are not necessarily to scale. Similar or functionally similar elements in the figures have been allocated the same numeral references, unless otherwise indicated.

Apparatuses, aircrafts, and methods, embodying the present invention will now be described, by way of non-limiting examples.

### DETAILED DESCRIPTION OF EMBODIMENTS OF THE INVENTION

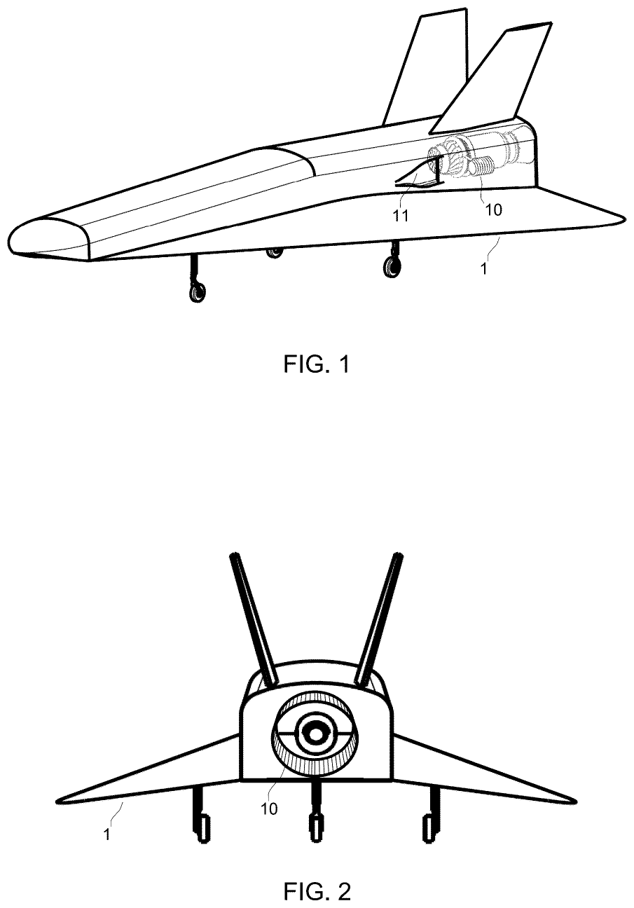

A first aspect of the invention is now described in reference to FIGS. 1-6, which concerns an air turborocket apparatus 10. Note, this apparatus may consist of a sole air turborocket or include an air turborocket connected to additional aircraft components, such as one or more fuel tanks, pumps, external compressors, batteries, etc., which together form an apparatus 10. The aircraft 1 itself concerns another aspect of the invention, which is described later.

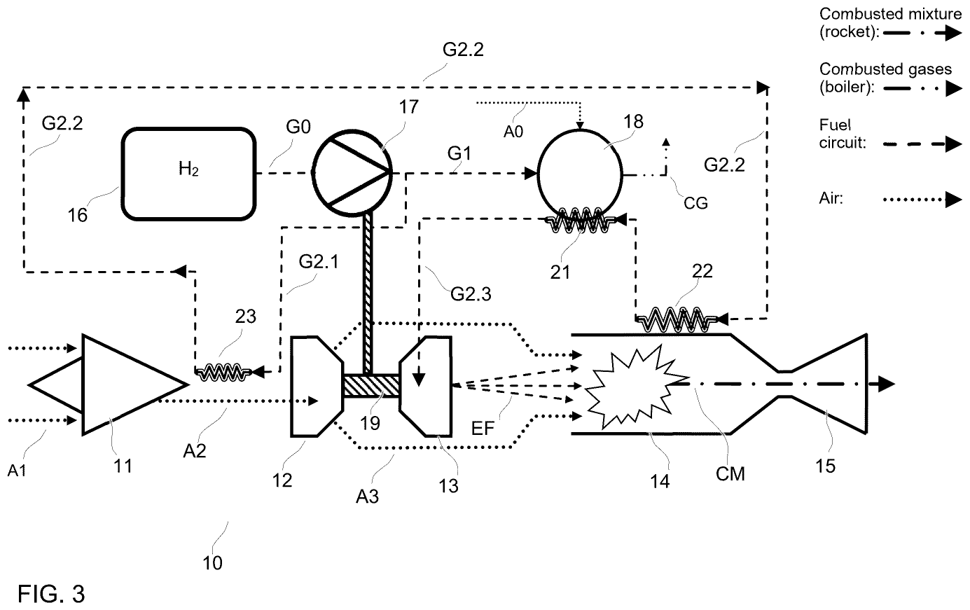

As seen in FIG. 3, the apparatus 10 notably includes an air intake 11, a compressor 12, a turbine 13, a gas generator system, a coupling system 19, a combustion chamber 14, and a nozzle 15.

The air intake 11 (also called air inlet) is designed to receive atmospheric air, the inlet flow of which is referred to as “A1” in FIG. 3. Various inlet designs are known (e.g., supersonic inlets, inlet cones, inlet ramps, etc.), which may be used in the present context. In general, the air intake is designed to ensure smooth airflow into downstream components of the engine.

The compressor 12 is designed to compress a flow A2 of atmospheric air received from the air intake 11, in operation. In FIG. 3, the flow A3 denotes compressed air, which is directed to the combustion chamber 14. Various compressor designs may be contemplated, starting with usual multi-stage compressors.

The gas generator system is meant to generate a fluid flow to actuate the turbine 13. The gas generator system includes a fluid circuit (see references G0-G2.3 in FIG. 3) and a driving system 17, 21-23. The fluid circuit G0-G2.3 notably defines a flow path G2.3 to the turbine 13. The driving system 17, 21-23 is generally designed to drive a high-pressure fluid and thus convey the fluid along the fluid circuit, with a view to eventually expanding the fluid EF through the turbine 13 and rotating the latter. In operation, the gas generator generates a flow of a fluid, which may be a liquid, a gas, or a supercritical fluid, notwithstanding the terminology “gas generator”. The state of matter may typically vary along the fluid circuit. For example, preferred embodiments rely on liquid hydrogen (LH₂), which is initially stored in a tank 16, pumped, and conveyed along the fluid circuit, where it is subject to such pressures and temperatures that is changes to supercritical H₂ (above 13 bars and −240 °C).

The role of the coupling system 19 is to couple the turbine 13 with one or each of the compressor 12 and (one or more elements of) the driving system 17, with a view to transferring energy to the compressor and/or the driving system. The coupling system 19 may for instance form a linkage between, on the one hand, the turbine 13 and, on the other hand, the compressor 12 and/or an element of the driving system 17 such as a pump 17 or an external compressor (distinct from the compressor 12). This linkage may for example be a purely mechanical system, e.g., involving gearboxes. In that case, the turbine is rotatably coupled to the compressor 12 and/or elements of the driving system 17.

In more sophisticated variants, the turbine 13 is indirectly coupled to the compressor and/or driving system, via an electromechanical system. For example, the apparatus 10 may include a battery. In that case, power required by the compressor 12 and/or the driving system 17 is provided both by the turbine 13 and the battery, rather than the sole turbine. In all cases, however, the energy produced by rotating the turbine causes (or contributes to cause) to rotate the compressor 12 and/or actuate the driving system 17, whether by directly transferring mechanical energy or by converting this energy to electrical power. In preferred embodiments, the coupling system is designed so that the turbine 13 drives (or contributes to drive) both the compressor 12 and a pump 17 of the driving system.

The combustion chamber 14 is designed to receive and combust a mixture A3, EF of the compressed atmospheric air A3 and the expanded fluid EF, as illustrated in FIG. 3. In operation, the chamber 14 continuously burns the expanded fluid after initial ignition during the engine start. The nozzle 15 is arranged downstream of the combustion chamber, so as to expel the combusted mixture CM and thereby create thrust, in operation of the apparatus 10. That is, the combusted mixture (exhaust gas) passes through the propelling nozzle to produce a high velocity jet. Various nozzle configurations may be involved. The nozzle may notably be configured as a supersonic nozzle.

Interestingly, the apparatus 10 further includes a boiler 18. The boiler is designed to generate heat. It is arranged in thermal communication with the flow path G2.3 leading to the turbine 13. To that aim, a heat exchanger 21 may thermally connect the boiler 18 with an end portion G2.3 of the flow path leading to the turbine 13, to efficiently transfer the heat generated by the boiler 18 to the fluid conveyed along this end portion G2.3. The heated fluid is accordingly expanded through the turbine 13 to more efficiently drive the compressor 12 and/or a component (e.g., the pump 17) of the driving system 17.

That is, the proposed solution provides an additional area for heat exchange, i.e., an additional surface through which heat can be transferred to the fluid circuit, while requiring minimal power. Indeed, the heat exchange mechanism at work involves two flows at different temperatures, which are put side by side, separated by a wall, so that the hot flow transfers heat to the cold flow. The heat transfer rate is the parameter that characterizes the performance of the heat exchange. The heat transfer rate can be averaged as \dot{Q}=UAΔTₘ, where \dot{Q} is the heat transfer rate, U is the overall heat transfer coefficient, A is the surface of the heat exchanger, and ΔTₘ is the average temperature difference between the hot and cold flows. The aim is to maximize the heat transfer rate. This can be achieved by maximizing the overall heat transfer coefficient, the surface of the heat exchanger, or the average temperature difference. The present solution amounts to inserting a new heat source (the boiler) in the fluid circuit and providing a heat exchange surface to maximize the heat transfer rate.

In preferred embodiments, the boiler is based on fuel combustion (instead of electrical power), which leads to a negligible fuel consumption. That is, the boiler 18 can be designed as a fuel boiler, i.e., an engine component that typically includes a burner combusting liquid or gas and a combustion chamber, where combustion takes place. Various fuel boiler designs are known in the art, which can be adapted for use in the present context. The boiler combustion chamber is in thermal contact with the fluid circuit, so that heat generated by the boiler 18 can be transferred to the fluid circuit.

The boiler 18 preferably uses the same liquid fuel as used in the main combustion line, e.g., liquid H₂. That is, the combustion inside the boiler can make use of a small portion of the engine fuel, combined with an oxidizer that may be carried onboard. In preferred variants, the oxidizer is air. The boiler may rely on non-compressed air (i.e., ambient air), which may be admitted A0 through a small vent, e.g., provided in a conduit downstream the air intake of the aircraft 1. In variants, it relies on compressed air, which is advantageously bled from the engine's compressor 12. In that case, a further air inlet may be configured to transfer part of the air compressed by the compressor 12 to the boiler 18. In both cases, the boiler is provided with air; the corresponding air path is symbolically represented by the arrow A0 in FIG. 3.

As opposed to the gas generator, which typically produces a high-pressure flow of fuel in the fluid circuit, the boiler 18 is typically designed to produce a low-pressure combustion gas flow CG. That is, the fluid directed to the turbine 13 has a much higher pressure than combustion gases produced by the boiler. For this reason, the gases produced by the boiler 18 will normally be expelled independently from the main combustion line. They will accordingly not contribute to generate thrust.

The boiler 18 may notably include a duct, connected to its combustion chamber, such that low-pressure combustion gases produced by the boiler 18 may be conveyed inside and along this duct. This duct is a passageway for gases resulting from the combustion taking place inside the boiler 18. Again, such gases are distinct from fluids conveyed in the fluid circuit and gases involved in the main combustion line, even if they can be produced from the same liquid fuel (e.g., LH₂). Consistently, the boiler's duct is not in fluid communication with the fluid circuit GO-G2.3, and the boiler 18 expels its combustion gases flow independently from the combusted mixture CM expelled by the nozzle 15.

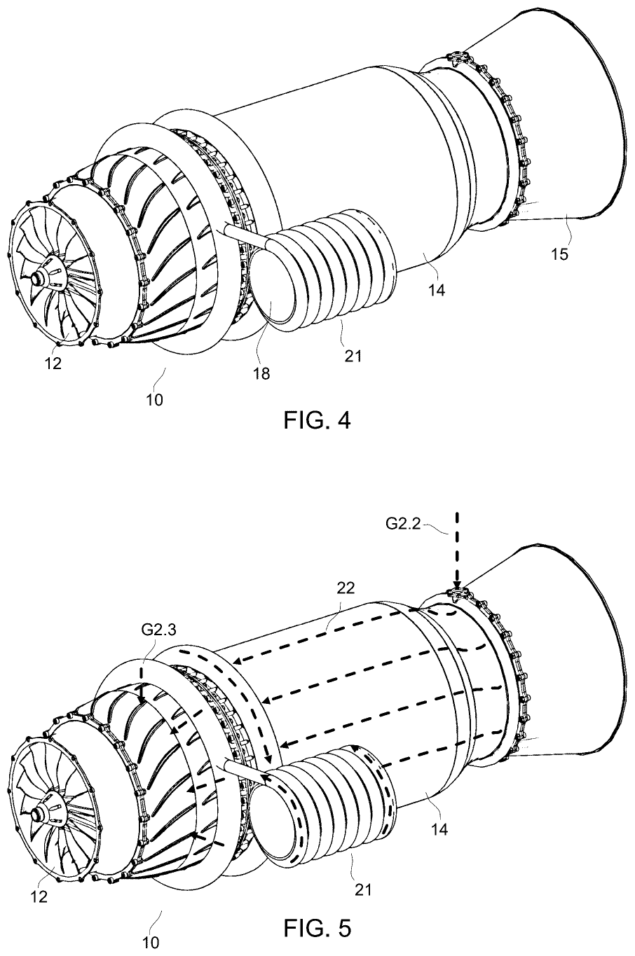

In embodiments, the heat exchanger 21 is formed by a conduit in thermal (e.g., direct) contact with the boiler 18. This conduit may for instance be a metal tube, e.g., a tube having diameter between 0.5 and 5 mm. The fluid circuit may use similar metal tubes. The fluid circuit may further include additional heat exchangers 22, 23, as discussed later. In detail, a portion G2.3 of the fluid circuit may include a conduit (e.g., a 2 mm diameter tube) that is coiled around the boiler's duct, as assumed in FIGS. 4 and 5. The coiled conduit forms a first heat exchanger 21, which efficiently transfers the heat generated by the boiler 18 to the fluid conveyed along the conduit. In the example of FIGS. 4 and 5, the conduit is coiled around an external wall of the boiler's duct. In variants, this conduit is coiled inside the duct, e.g., against an inner wall delimiting the duct. The conduit may also be coiled around the boiler 18, against an outer wall of, e.g., the combustion chamber of the boiler. In further variants, this conduit may also be arranged in the thickness of a wall delimiting the duct or the combustion chamber. Various other heat exchanger designs can be contemplated.

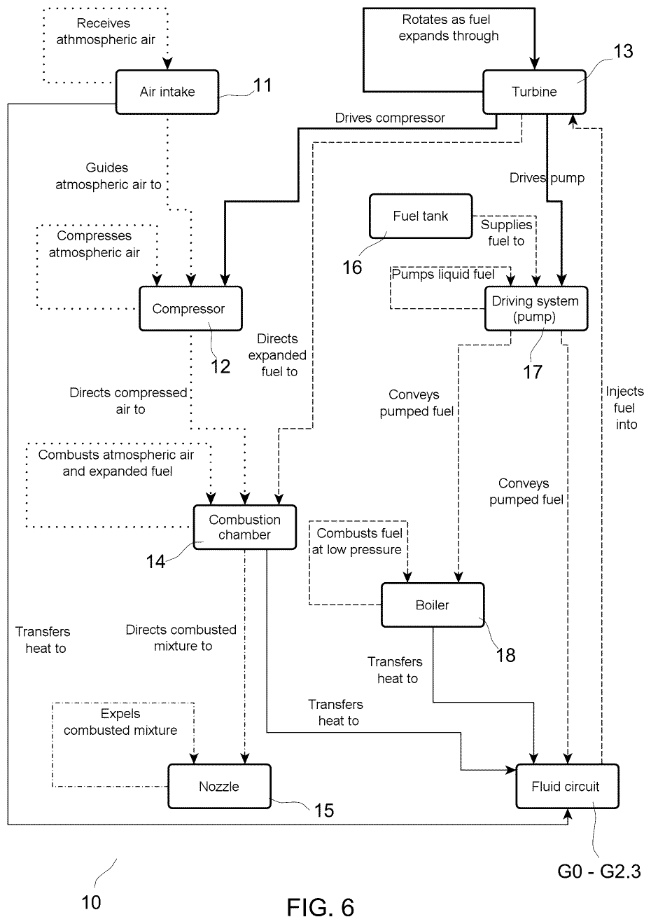

The following describes the coupling system 19. As illustrated in FIGS. 3 and 6, the coupling system 19 is generally configured to couple the turbine 13 with the compressor 12. As explained earlier, this allows the rotated turbine to (at least) contribute to drive the compressor 12 and/or the driving system 17. In preferred embodiments, the turbine is coupled to the compressor 12, to rotate it and accordingly compress atmospheric air A2 received from the air intake 11. I.e., the turbine 13 and the compressor 12 form a turbine-compressor assembly. As said, the rotation of the compressor may be entirely driven by the rotating turbine, via gearboxes. In that case, the mechanical energy of the rotated turbine 13 is transferred to rotate the compressor. In variants, the rotated turbine may only be indirectly coupled to the compressor. For example, the rotation of the turbine may first be converted into electrical power, which is then used to rotate the compressor. Part of the electrical power generated by the turbine 13 may be used to power the boiler, should it be an electric boiler. Additional electric power (e.g., from an external battery) may further be applied to actuate the compressor, if necessary. In that case, the turbine rotation only contributes to rotate the compressor, which is secondarily powered by another source.

The driving system 17, 21-23 typically includes a pump 17 which is designed to pump liquid fuel (e.g., H₂), as illustrated in FIG. 3. The pump is connected to the fluid circuit G0-G2.3 to inject pumped liquid fuel into the fluid circuit. I.e., the fluid conveyed along the fluid circuit is initially obtained from pumped liquid fuel. In variants, or in addition to the pump 17, the driving system may also involve one or more external compressors (distinct from the compressor 12), to apply pressure to the liquid fuel upon injecting it into the fluid circuit.

The components of the driving system require power too, hence the benefit of harnessing power generated from the turbine 13. Thus, in embodiments, the coupling system 19 couples the turbine 13 with one or more elements of the driving system, e.g., a pump 17. In that case, the rotated turbine 13 actuates (or contributes to actuate) the pump 17. In preferred embodiments, the turbine rotation is exploited to actuate both the compressor 12 and one or more elements of the driving system 17. A preferred scenario is one in which the coupling system 19 couples the turbine 13 with each of the pump 17 and the compressor 12. Again, the turbine may only be indirectly coupled to such elements, which may further be secondarily powered by another source (e.g., a battery), if necessary.

The following discusses embodiments of the fluid circuit structure. Referring to FIG. 3, the fluid circuit G0-G2.3 preferably include two subcircuits, namely a first subcircuit G1 and a second subcircuit G2.1-G2.3. The first subcircuit connects the pump 17 to the boiler 18. The role of the first subcircuit G1 is to convey a fluid obtained from the pumped liquid fuel to the boiler 18, for the boiler to subsequently combust this fuel and heat another part of the fluid circuit, i.e., the second subcircuit G2.1-G2.3. The latter defines a flow path to the turbine 13; it is used to convey the high-pressure flow of fluid produced by the gas generator to the turbine 13, with a view to actuating the turbine as the high-pressure flow expands through it. To that aim, the second subcircuit G2.1-G2.3 defines a flow path connecting the pump 17 to the turbine 13.

The second subcircuit notably includes an end portion G2.3, which ends up at the turbine 13. Now, the first heat exchanger 21 may be arranged so as to thermally connect the boiler 18 with the end portion G2.3 of the flow path to the turbine 13. The function of this heat exchanger 21 is to efficiently transfer the heat generated by the boiler to high-pressure fluid conveyed to the turbine. This way, the boiler 18 and the heat exchanger 21 provides additional area for heat exchange, subject to a minimal fuel consumption increase. As noted earlier, the first heat exchanger 21 may form an integral part of the second subcircuit, i.e., a portion of the second fluid subcircuit, which may for instance be formed as a conduit (e.g., a metal tube) coiled around or inside the boiler 18 (or a duct thereof).

For completeness, an additional section GO connects the tank 16 to the pump 17. This section is not directly connected to the two subcircuits G1, G2. Note, the design shown in FIG. 3 suggests that the first subcircuit branches from the second subcircuit, whereby a small part of the pumped fuel is passed to the boiler, the rest being directed to the turbine. Another option is to independently pump fuel meant to the boiler and the turbine, which may require two pumps, possibly connected to a same tank or respective tanks.

The apparatus 10 may further include additional heat exchangers 22, 23. For example, a second heat exchanger 22 may advantageously be arranged along the second subcircuit G2.1-G2.3, yet upstream of the first heat exchanger 21, e.g., close to the combustion chamber 14, so as to transfer heat from the combustion chamber 14 to the conveyed fluid. Further heat exchangers may be provided to harness heat generated in other locations of the apparatus 10. For example, the driving system may include a third heat exchanger 23 arranged along the second subcircuit G2.1-G2.3, upstream of the second heat exchanger 22, to transfer heat generated by the air intake 11 to fluid conveyed along the second subcircuit. The heat exchanger 23 acts as a pre-cooler, which cools down incoming air. The supercritical phase of H₂ is typically achieved after the pre-cooler 23, in operation. In variants, several heat exchangers may actually be used instead of the single heat exchanger 23 shown in FIG. 3; such heat exchangers may for instance be configured as a two-stage pre-cooler, just behind the inlet. Another heat exchanger may also be arranged in proximity with the compressor 12.

The boiler and heat exchangers are preferably made of high-performance materials that can withhold high temperatures and transfer heat efficiently. Examples of such materials include aerospace standard stainless steel, titanium alloys, and nickel alloys. The heat exchangers can advantageously be configured as coiled conduit sections, cooling jackets, or involve microchannels. A characteristic dimension of the heat exchanger (e.g., the cooling jacket thickness or the cross-sectional diameter of the microchannels) will typically be on the order of 1/200 of the engine diameter. Still, this dimension may possibly be scaled down, the manufacturing process permitting. The ratio of a characteristic diameter of the boiler (e.g., the diameter of the boiler's duct) to the engine diameter will typically be between ¼ and 1, although the boiler may also possibly be scaled down, depending on the boiler type and performance.

The above embodiments have been succinctly described in reference to the accompanying drawings and may accommodate a number of variants. Several combinations of the features described above may be contemplated. For example, as illustrated in the diagram of FIG. 3, the apparatus 10 relies on a single fuel tank 16 storing liquid fuel, which is pumped by the pump 17. The pumped fuel is then injected into a subsection G2.1-G2.3 of the fluid circuit, with relatively high pressure, while a small portion of the pumped fuel is bled to the boiler 18, via another fluid circuit subsection G1. The boiler 18 combusts the fuel (at low pressure) thanks to atmospheric air bled from an air intake 11. The heat generated by the boiler 18 is transferred to an end portion G2.3 of the fluid circuit subsection G2.1-G2.3, thanks to a heat exchanger 21, which actually forms part of the fluid circuit. That is, the heat exchanger 21 is formed as a conduit portion (a 2 mm metal tube), which is coiled around a duct of the boiler, as illustrated in FIGS. 4 and 5.

The pumped fuel is injected in an upstream portion G2.1 of the fluid circuit, leading to another heat exchanger (pre-cooler) 23, which cools down air received by the air inlet 11. After that the heated fuel (which now may be in a supercritical state) reaches a further circuit section G2.2, which conveys the fluid to a further heat exchanger 22. The latter absorbs heat from the combustion chamber 14, upstream of the heat exchanger 21. The end portion G2.3 of the fluid circuit brings the fluid to the turbine 13. The fluid accordingly expands EF through the turbine 13, causing the turbine 13 to rotate. The turbine is coupled to each of the compressor 12 and the pump 17 via a coupling system 19 involving gearboxes, to transfer energy to such elements. Air A3 compressed by the compressor 12 is conveyed to the combustion chamber 14, which further receives the expanded fluid EF. The mixture is combusted in the chamber 14 and expelled by the nozzle 15 to create thrust.

FIG. 5 schematically illustrates the flow path of the pumped fuel in the second subcircuit. Fuel is injected from the second fluid circuit portion G2.2 into the heat exchanger 22. In this example, the exchanger 22 is made of metal conduits extending inside the combustion chamber 14, against an inner wall thereof. The fuel is accordingly heated and conveyed to the boiler 18, via a fluid conduit 21 that is coiled around a duct of the boiler, thus forming a further heat exchanger 21. Thus, the fluid is further heated, prior to being injected to the turbine 13 via the end portion G2.3 of the flow path.

The functions of the main components of the apparatus 10 are summarized in the diagram of FIG. 6. Of course, the apparatus 10 may include additional components (not shown), such as bypass ducts, shafts, diffuser sections, etc., as usual in the field of air turborockets.

Referring now more specifically to FIGS. 1 and 2, another aspect of the invention concerns an aircraft 1, which is equipped with one or more air turborocket apparatuses 10 as described above in reference to FIGS. 3-6 . The aircraft 1 may notably be a drone or a high-speed plane, such as a supersonic or hypersonic plane. As usual, the aircraft 1 includes an aircraft structure (or airframe), i.e., the internal load bearing structure, which is a structural assembly typically made from frames, stringers, spars, ribs, and panels, which are usually machined or formed from sheet metal. The airframe houses a number of components, starting with the air turborocket(s) 10 and the fuel tanks 16, to which the gas generator system and the boiler 18 are connected, e.g., via one or more pumps 17, as explained earlier.

A final aspect of the invention concerns a method of operating an air turborocket apparatus 10, or actually an aircraft 1 including such an apparatus 10, as described above. The method basically revolves around operating the air turborocket apparatus for the air intake 11 to receive atmospheric air A1, the compressor 12 to compress atmospheric air A2 received by the air intake 11, and the driving system 17, 21-23 to convey a fluid along the fluid circuit. As explained earlier, the aim is to expand the fluid EF through the turbine 13 and rotate the turbine, to transfer energy to one or each of the compressor 12 and the driving system. This causes the combustion chamber 14 to receive and combust a mixture of the compressed atmospheric air A3 and the expanded fluid EF, which is subsequently expelled by the nozzle 15 to create thrust. Meanwhile, the boiler 18 is operated to generate heat and transfer the generated heat to the fluid conveyed along the flow path to the turbine, with a view to improving the efficiency of the process.

While the present invention has been described with reference to a limited number of embodiments, variants and the accompanying drawings, it will be understood by those skilled in the art that various changes may be made, and equivalents may be substituted without departing from the scope of the present invention. In particular, a feature (device-like or method-like) recited in a given embodiment, variant or shown in a drawing may be combined with or replace another feature in another embodiment, variant or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention is not limited to the particular embodiments disclosed, but that the present invention will include all embodiments falling within the scope of the appended claims. In addition, many other variants than explicitly touched above can be contemplated. For example, the apparatus 10 may involve other materials and other components than those explicitly mentioned above. In addition, other air turborocket designs may be contemplated, which may depart from the design shown in FIGS. 4 and 5.

### REFERENCE LIST

1 Aircraft
10 Air turborocket apparatus
11 Air intake
12 Compressor
13 A turbine
14 Combustion chamber
15 Nozzle
16 Fuel tank
17 Driving system pump
17, 21-23 Driving system
18 Boiler
19 Coupling system
21 First heat exchanger
22 Second heat exchanger
23 Third heat exchanger
A1 Atmospheric air received by the air intake
A2 Atmospheric air led to the compressor
A3 Compressed atmospheric air
CM Combusted mixture
EF Expanded fluid
GO-G1.3 Fluid circuit
GO-G1.3 Fluid circuit section connecting tank with pump
G0 First fluid subcircuit
G1 (G1.1-G1.3) Second fluid subcircuit
G1.1 First portion of the second fluid subcircuit
G1.1 Second portion of the second fluid subcircuit
G1.1 End portion of the second fluid subcircuit
G1.3 End portion of flow path to turbine

1. An air turborocket apparatus comprising:
an air intake designed to receive atmospheric air;
a compressor designed to compress atmospheric air received by the air intake,
a turbine,
a gas generator system including
a fluid circuit defining a flow path to the turbine and
a driving system designed to convey a fluid along the fluid circuit for the fluid to expand through the turbine and rotate it, a coupling system coupling the turbine with one or each of the compressor and the driving system, to transfer energy to one or each of the compressor and the driving system;
a combustion chamber designed to receive and combust a mixture of the compressed atmospheric air and the expanded fluid;
a nozzle arranged to expel the combusted mixture and thereby create thrust; and
a boiler designed to generate heat, wherein the boiler is in thermal communication with said flow path to transfer the generated heat to the fluid conveyed along said flow path.

2. The air turborocket apparatus according to claim 1, wherein
the coupling system couples the turbine with the compressor, whereby the rotated turbine at least contributes to rotate the compressor to accordingly compress the atmospheric air received by the air intake in operation.

3. The air turborocket apparatus according to claim 1, wherein
the driving system includes a pump designed to pump liquid fuel, the pump connected to the fluid circuit to inject the pumped liquid fuel into the fluid circuit whereby said fluid is obtained from the pumped liquid fuel, in operation.

4. The air turborocket apparatus according to claim 3, wherein
the coupling system couples the turbine with the pump, whereby the rotated turbine at least contributes to actuate the pump, in operation.

5. The air turborocket apparatus according to claim wherein
the fluid circuit comprises two subcircuits, these including a first subcircuit and a second subcircuit,
the first subcircuit connects the pump to the boiler, which can accordingly combust a fluid formed from the pumped liquid fuel, and
the second subcircuit connects the pump to the turbine thereby defining said flow path to the turbine.

6. The air turborocket apparatus according to claim 5, wherein
the apparatus further includes a first heat exchanger, which thermally connects the boiler and a portion of the flow path defined by the second subcircuit, to transfer the generated heat to the fluid conveyed along the second subcircuit.

7. The air turborocket apparatus according to claim 6, wherein
the apparatus further includes a second heat exchanger arranged along the second subcircuit, upstream of the first heat exchanger, to transfer heat from the combustion chamber and/or the nozzle to fluid conveyed along the second subcircuit.

8. The air turborocket apparatus according to claim 7, wherein
the driving system, further includes a third heat exchanger arranged along the second subcircuit, upstream of the second heat exchanger, to transfer heat from the atmospheric air received by the air intake to fluid conveyed along the second subcircuit.

9. The air turborocket apparatus according to claim 1, wherein
the boiler is designed to combust fuel and produce a low-pressure combustion gas flow, and
the gas generator is designed to produce a high-pressure flow of the fluid in the fluid circuit.

10. The air turborocket apparatus according to claim 9, wherein
the boiler is designed to produce said low-pressure combustion gas flow inside a duct delimited by an inner wall of the boiler.

11. The air turborocket apparatus according to claim 10, wherein
a portion of the fluid circuit includes a conduit that is coiled around the duct, thereby forming a heat exchanger to transfer the generated heat to the fluid conveyed along said conduit.

12. The air turborocket apparatus according to claim 11, wherein
the conduit is coiled inside the boiler, against said inner wall of the boiler.

13. The air turborocket apparatus according to claim 11, wherein
said portion of the conduit is coiled around the boiler, against an outer wall of the boiler.

14. The air turborocket apparatus according to claim 10, wherein
the duct is not in fluid communication with said fluid circuit.

15. The air turborocket apparatus according to claim 9, wherein
the apparatus further includes an air inlet configured to transfer part of the atmospheric air compressed by the compressor to the boiler, in operation.

16. An aircraft comprising
one or more air turborocket apparatuses, each comprising:
an air intake designed to receive atmospheric air;
a compressor designed to compress atmospheric air received by the air intake,
a turbine,
a gas generator system including
a fluid circuit defining a flow path to the turbine and
a driving system designed to convey a fluid along the fluid circuit for the fluid
to expand through the turbine and rotate it,
a coupling system coupling the turbine with one or each of the compressor and the driving system, to transfer energy to one or each of the compressor and the driving system;
a combustion chamber designed to receive and combust a mixture of the compressed atmospheric air and the expanded fluid;
a nozzle arranged to expel the combusted mixture and thereby create thrust; and
a boiler designed to generate heat, wherein the boiler is in thermal communication with said flow path to transfer the generated heat to the fluid conveyed along said flow path.

17. The aircraft according to claim 16, wherein
the aircraft further includes one or more fuel tanks, to which the gas generator system and the boiler are connected.

18. A method of operating an air turborocket apparatus, the method comprising:
providing an air turborocket apparatus comprising:
an air intake designed to receive atmospheric air;
a compressor designed to compress atmospheric air received by the air intake,
a turbine,
a gas generator system including
a fluid circuit defining a flow path to the turbine and
a driving system designed to convey a fluid along the fluid circuit for the fluid
to expand through the turbine and rotate it,
a coupling system coupling the turbine with one or each of the compressor and the driving system, to transfer energy to one or each of the compressor and the driving system;
a combustion chamber designed to receive and combust a mixture of the compressed atmospheric air and the expanded fluid;
a nozzle arranged to expel the combusted mixture and thereby create thrust; and
a boiler designed to generate heat, wherein the boiler is in thermal communication with said flow path to transfer the generated heat to the fluid conveyed along said flow path; and
operating the air turborocket apparatus for:
the air intake to receive atmospheric air;
the compressor to compress atmospheric air received by the air intake
the driving system to convey a fluid along the fluid circuit for the fluid to expand through the turbine and rotate it, to transfer energy to one or each of the compressor and the driving system;
the boiler to generate heat and transfer the generated heat to the fluid conveyed along said flow path;
the combustion chamber to receive and combust a mixture of the compressed atmospheric air and the expanded fluid; and
the nozzle to expel the combusted mixture and thereby create thrust.
